(19) United States
(12) Patent Application Publication
(10) Pub. No.: US 2005/0123729 A1
(43) Pub. Date: Jun. 9, 2005

(54) Security document card and method for production thereof

(76) Inventors: Guenter Beyer-Meklenburg, Neuruppin (DE); Wilfried Hartmann, Oldenburg (DE); Werner Janssen, Varel (DE)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/506,436

(22) PCT Filed: Feb. 26, 2003
(86) PCT No.: PCT/EP03/01955

(30) Foreign Application Priority Data
Mar. 7, 2002 (DE) 102 10 182.5

(51) Int. Cl. B32B 3/00

(52) U.S. Cl. 428/195.1

(57) ABSTRACT

A security document card and method for production thereof are disclosed, whereby the card comprises a support (10) and a coating (5), arranged on at least one side of the support. The material of the support comprises high-density polyethylene (HDPE) and linear low-density polyethylene (LLDPE). The material of the coating comprises polycarbonate. The support and the coating are joined by means of hot glue.

### PRIOR ART

The invention is based on a security document card comprising a support and a coating, arranged at least on one side of the support, of the type in independent claim 1. The invention is also based on a method for producing such a security document according to the preamble of the further independent claim.

Security document cards made of polycarbonate and methods for producing these polycarbonate security document cards are already known. However, security document cards of this type have the drawback that they break very easily. Security document cards of this type are sewn or glued into passports, for example, the card then having regions in which it is severely bent and/or there are perforations as a result of the seam. After gluing or sewing the card into a passport and frequent opening and closing of the passport, the material is so severely stressed that a card of this type breaks very easily at the bending and seam points, which can be understood as breaking points, and the security document card is thus detached from the passport.

### ADVANTAGES OF THE INVENTION

The security document card according to the invention with the feature of the independent claim has, by contrast, the advantage that a card of this type has a greater breaking strength. It is also advantageous that the temperature stability and the environmental compatibility of the material are judged to be good. Information may also still be printed onto the security document card or written on or engraved using lasers.

Advantageous developments of and improvements to the security document card indicated in the independent claim are possible as a result of the measures recited in the sub-claims. It is particularly advantageous that the support material can also be provided with a filler, so the properties of the support material can be positively influenced, for example with respect to the colour of the material. The fillers TiO₂ and/or CaCO₃ have proven to the particularly advantageous here. To achieve the desired change in the properties of the support material it is advantageous to select the filler content so as to be at least 5% by weight, more advantageously so as to be at least 20% by weight. For an advantageous configuration of the security document card with the desired rigidities it is advantageous to select the thickness of the support so as to be at least 100 μm. The layer thickness of the coating should advantageously be less than the layer thickness of the support. The coating material may be particularly easily and durably fastened to the support material by means of a hot-melt adhesive. The information provided on the security document card is advantageously located on the coating and is printed there or written on or engraved by means of lasers.

The method according to the invention for producing the security document card with the features of the independent claim has the advantage that the security document card according to the invention can be produced easily and inexpensively.

Advantageous developments of and improvements to the method recited in the sub-claim for producing the security document card are possible as a result of the measures listed in the sub-claims. It is particularly advantageous to select the temperature at which the hot-melt adhesive is activated so as to be in a range between 100° C. and 200° C. as the plastics material is not affected under these conditions. To provide the appropriate information on the security document card it is advantageous to imprint the coating and/or to write on or engrave information by means of lasers before and/or after fastening to the support.

### DRAWING

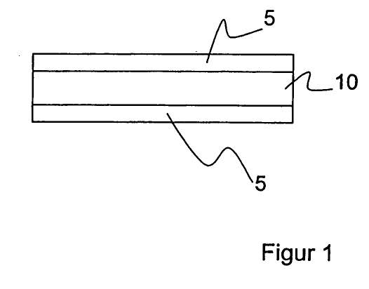

Embodiments of invention are illustrated with the aid of a drawing and described in more detail in the following description. FIG. 1 shows (schematically) the cross-section of a security document card according to the invention.

### DESCRIPTION OF THE EMBODIMENTS

FIG. 1 schematically shows a cross-section of an embodiment for a security document card according to the invention. The security document card illustrated there is constructed from three layers. The support 10 is arranged centrally and has a respective coating 5 on the outside. A security document card of this type can be sewn or glued into a passport. In a further embodiment the coating 5 can also be provided on just one side of the support 10. The material of the support 10 consists of high density polyethylene (HDPE) and linear low density polyethylene (LLDPE). In a further preferred embodiment the security document card also contains a filler advantageously consisting of TiO₂ and/or CaCO₃. The filler content in the material of the support is advantageously at least 5% by weight, wherein in a further advantageous embodiment the filler content in the support material is at least 20% by weight. The filler is substantially responsible for the colouring of the support material.

The material of the coating 5 contains polycarbonate. In a further embodiment the coating 5 is configured in such a way that the coating is transparent in at least one region. To ensure the requisite rigidity of the security document card, the layer thickness of the support 10 is selected such that it is at least 100 μm. It has proven to be advantageous for the thickness of the coating to not be greater than the thickness of the support. In a further particularly preferred embodiment the thickness of the support is 120 μm while the thickness of the coating material is 100 μm.

The production of the security document card is to be described hereinafter. The sides, on which the coating 5 is to be arranged, of the support 10, which in a preferred embodiment can also comprise imprinted information, are firstly brushed over with a hot-melt adhesive. The hot-melt adhesive is then activated in that it is heated to temperatures between 100° C. and 200° C. In a particularly preferred embodiment the hot-melt adhesive is heated to a temperature between 140° C. and 150° C. The coating is then arranged on the activated hot-melt adhesive, a rigid connection between support 10 and coating 5 being produced on cooling of the hot-melt adhesive. To introduce information into the coating 5, information is written on or engraved in the coating by means of lasers. In a further preferred embodiment, information is printed onto the coating by means of conventional printing methods. Said information is provided or introduced after connection of the coating to the support. In a further embodiment the information, which is written on or engraved by means of lasers or imprinted, is provided prior to the arrangement of the coating on the support provided with hot-melt adhesive.

The security document card produced by the above-described method ensures that the security document card subsequently glued or sewn into a passport does not detach from the passport over the service life thereof, despite high stressing owing to bending, but simultaneously has good properties with respect to temperature stability, environmental compatibility and the possibility of introducing information.

1. Security document card comprising a support (10) and a coating (5) arranged at least on one side of the support, characterised in that the material of the support (10) contains high density polyethylene (HDPE) and linear low density polyethylene (LLDPE) and the material of the coating (5) contains polycarbonate.

2. Security document card according to claim 1, characterised in that the material of the support also contains a filler.

3. Security document card according to claim 2, characterised in that the filler contains TiO₂ and/or CaCO₃.

4. Security document card according to claim 2, characterised in that the filler content in the material of the support is at least 5% by weight.

5. Security document card according to claim 2, characterised in that the filler content in the material of the support is at least 20% by weight.

6. Security document card according to claim 1, characterised in that the layer thickness of the support is at least 100 μm.

7. Security document card according to claim 1, characterised in that the layer thickness of the coating is less than the layer thickness of the support.

8. Security document card according to any one of claims 1 to 7, 17, or 18, characterised in that the layer thickness of the support is at least 120 μm and the layer thickness of the coating is at least 100 μm.

9. Security document card according to any one of claims 1 to 7, 17 or 18, characterised in that the coating is fastened to the support by means of hot-melt adhesive.

10. Security document card according to claim 1, characterised in that the coating comprises information engraved or written on by means of a laser.

11. Security document card according to claim 1, characterised in that the coating comprises printed information.

12. Method for producing a security document card comprising a support (10) and a coating (5) arranged at least on one side of the support, characterised in that the coating containing polycarbonate is fastened to the support by means of hot-melt adhesive, the material of the support containing high density polyethylene (HDPE) and linear low density polyethylene (LLDPE).

13. Method according to claim 12, characterised in that the temperature at which the hot-melt adhesive is activated is above 100° C. and below 200° C.

14. Method according to either claim 12 or claim 13, characterised in that information is engraved or written on a coating by means of lasers before and/or after fastening to the support.

15. Method according to either claim 12 or 13, characterised in that the coating is imprinted before and/or after fastening to the support.

16. Method according to claim 14, characterised in that the coating is imprinted before and/or after fastening to the support.

17. Security document card according to claim 3, characterised in that the filler content in the material of the support is at least 5% by weight.

18. Security document card according to claim 3, characterised in that the filler content in the material of the support is at least 20% by weight.
